(19) United States
(12) Patent Application Publication
(10) Pub. No.: US 2003/0065528 A1
(43) Pub. Date: Apr. 3, 2003

(54) Ticket issuing and examining system and a method for issuing a ticket

(76) Inventor: Kozo Matsumoto, Tokyo (JP)

Correspondence Address: PILLSBURY WINTHROP, LLP, P.O. BOX 10500, MCLEAN, VA, 22102, US

(21) Appl. No.: 10/232,380

(22) Filed: Sep. 3, 2002

(30) Foreign Application Priority Data
Sep. 29, 2001 (JP) P2001-375012

(51) Int. Cl. G06F 17/60

(52) U.S. Cl. 705/1; 705/73; 705/5

(57) ABSTRACT

A ticket issuing and examining system comprises a ticket issuing management center, an automatic gate apparatus, and a ticket issuing apparatus. The ticket issuing management center receives an ID code of a user and a ticket data desired to purchase and transmitted from the user who has an ID recording medium recording an ID code thereon through a communication line and stores the received ID code and the ticket data in a memory by correlating them. The automatic gate apparatus reads an ID code from an ID recording medium and based on this read ID code, judges the entry of a user for approval or disapproval, and when the entry is judged to be approved, approves the entry of a user. Further, the ticket issuing management center receives an ID code transmitted from the automatic gate apparatus and based on this received ID code, reads out ticket data from a memory, and transmits the ticket data and the ID code to the ticket issuing apparatus. The ticket issuing apparatus receives the ID code and the ticket data transmitted from the ticket issuing management center and issues a ticket based on the received ticket data.

### CROSS-REFERENCE TO RELATED APPLICATION

The present application is based upon and claims the benefit of priority from the prior Japanese Patent Application No. 2001-375012, filed on Sep. 29, 2001: the entire contents of which are incorporated herein by reference.

### BACKGROUND OF THE INVENTION

The present invention relates to a ticket issuing and examining system to issue a ticket to a user in transport facilities such as railways and a method for issuing a ticket.

In recent years, a system to sell tickets for transport facilities has come in the practical use. According to this system, a user first books to purchase a ticket by way of the Internet service. Then, prior to board on a train, the user goes to a ticket window at a station and gets a booked ticket.

However, according to a conventional ticket issuing system, even when a user books to purchase a ticket by way of the Internet service, it is necessary for a user to take a step to get a ticket at a ticket window of a station before boarding a train and may waste a time at a station if the ticket window is crowded.

### BRIEF SUMMARY OF THE INVENTION

An object of this invention is to provide a ticket issuing and examining system and a method for issuing a ticket, which are capable of dissolving a problem of wasting a time for getting a reserved ticket.

According to this invention, a ticket issuing and examining system is provided. This system comprises: a ticket issuing management center including: means for accepting an ID code and ticket data desired to purchase that are transmitted through a communication line from a user who has an ID recording medium with an ID code recorded thereon; and means for storing the ID code and the ticket data accepted by the accepting means by correlating them: an automatic gate apparatus including: means for reading the ID code from the ID recording medium; means for judging whether the entry of a user to approve or not according to the ID code read by the reading means; means for transmitting the ID code to the ticket issuing management center when the entry of a user is judged to be approved by the judging means; and means for approving the entry of the user when the entry is judged to be approved by the judging means; wherein the ticket issuing management center further including: means for receiving the ID code transmitted from the transmitting means of the automatic gate apparatus; and ticket data transmitting means for reading the ticket data from the storing means based on the ID code received by the receiving means and transmitting the read ticket data and the ID code; a ticket issuing apparatus including: means for receiving the ID code and the ticket data transmitted from the ticket data transmitting means of the ticket issuing management center; and means for issuing a ticket based on the ticket data received by the receiving means of the ticket issuing apparatus.

Further, according to the present invention, a method for issuing a ticket is provided. This method comprises: receiving an ID code and ticket data of a ticket desired by a user to purchase that are transmitted from the user who has an ID recording medium with the ID code recorded thereon through a communication line by the ticket issuing management center; storing the received ID code and the ticket data in a storing means of the ticket issuing management center by correlating them; reading the ticket data from the storing means according to the received ID code and transmitting the read out ticket data and the ID code to a ticket issuing apparatus; receiving the ID code transmitted from the ticket issuing management center by an automatic gate apparatus; judging whether the passage of the user having the ID recording medium to approve or not by the automatic gate apparatus based on the received ID code; receiving the transmitted ticket data and ID code by the ticket issuing apparatus; and issuing a ticket based on the received ticket data by the ticket issuing apparatus.

### BRIEF DESCRIPTION OF THE DRAWINGS

FIG. 1 is a conceptual diagram of a ticket issuing and examining system involved in the embodiment of the present invention;

FIG. 2 is a block diagram showing a schematic structure of the ticket issuing and examining system involved in the embodiment of the present invention; and

FIG. 3 is a flowchart for explaining the ticket issuing process according to the ticket issuing and examining system.

### DETAILED DESCRIPTION OF THE INVENTION

A preferred embodiment of the present invention will be explained below referring to the drawings.

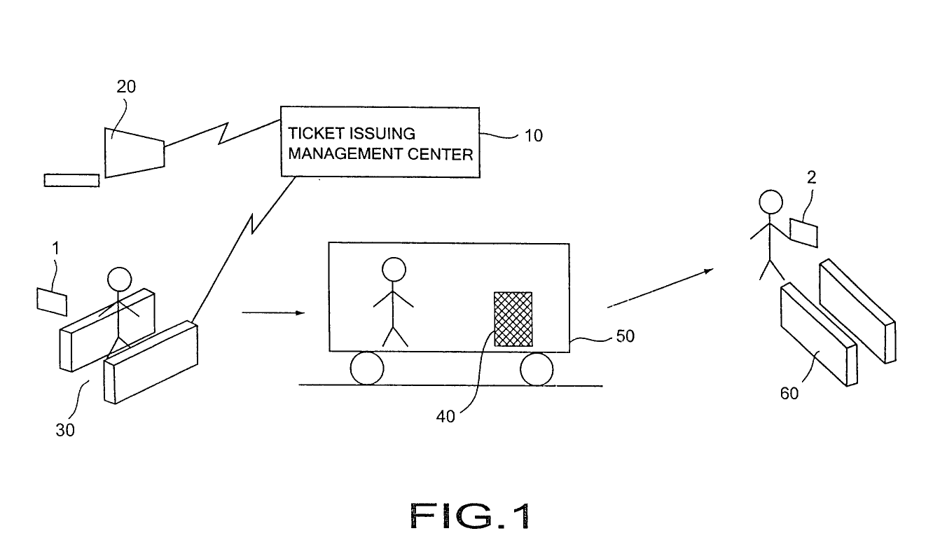

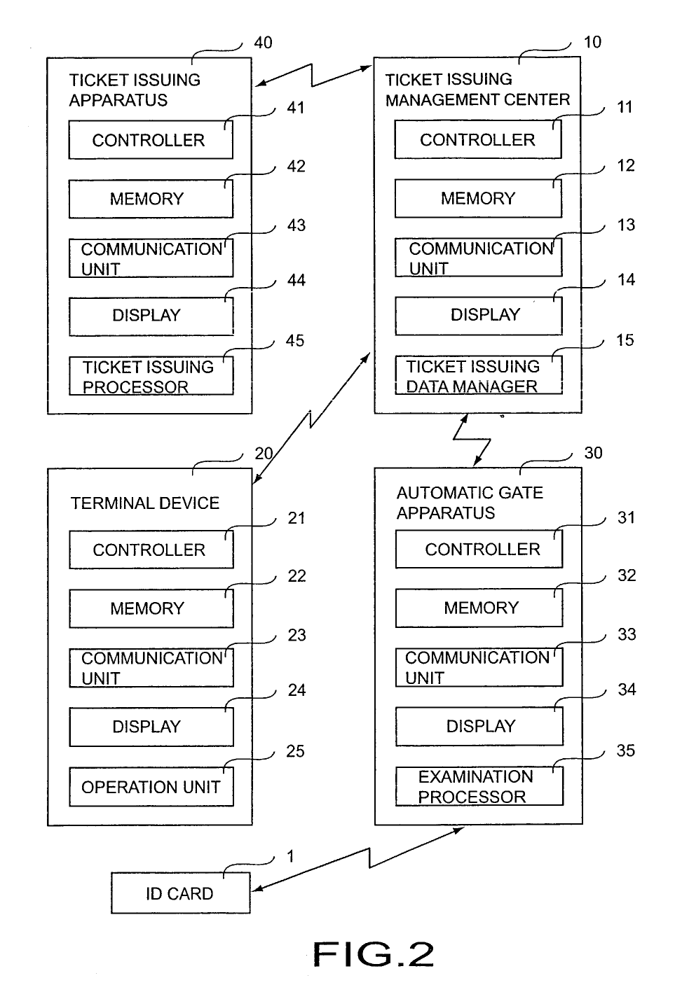

FIG. 1 and FIG. 2 show the schematic structure of a ticket issuing and examining system involved in a preferred embodiment of the present invention.

As shown in FIG. 1 and FIG. 2, the ticket issuing and examining system is composed of: a ticket issuing management center 10, an automatic gate apparatus 30, and a ticket issuing apparatus 40. A terminal device 20 is, for example, a cell phone, a portable terminal device or a PC (personal computer). An ID card (an ID code recording medium) 1 may be a wireless card or a magnetic card. On the ID card 1, an ID code is recorded for identifying a user.

The ticket issuing management center 10 is composed of a controller 11, a memory 12, a communication unit 13, a display 14 and a ticket issuing data manager 15. The controller 11 controls component units according to an operating program stored in the memory 12 for executing the ticket issuing management process that will be described later. The memory 12 stores various data including the operating program of the controller 11, passenger fared, etc. The communication unit 13 exchanges various data among the terminal device 20, the automatic gate apparatus 30 and the ticket issuing apparatus through the wireless communication. The display 14 displays various data relative to the ticket issuing management. The ticket issuing data manager 15 manages ticket issue data relative to tickets issued in response to ticket issuing requests from the terminal device 20. That is, the ticket issuing data manager 15 receives and accepts an ID code and ticket data of a ticket desired by a user to get, which are transmitted from a user through the terminal device, and manages the ID code and the data by correlating them in the memory.

The terminal device 20 is composed of: a controller 21, a memory 22, a communication unit 23, a display 24 and an operation unit 25. The controller 21 controls the operation unit 25 to transmit a ticket issue request to the ticket issuing management center 10. The memory 22 stores various data including an operating program of the controller 21. The communication unit 23 exchanges various data with the ticket issuing management center 10. The display 24 displays various data relative to purchase of tickets. The controller 25 accepts various operations relative to purchase of tickets.

The automatic gate apparatus 30 is composed of: a controller 31, a memory 32, a communication unit 33, a display 34, and an examination processor 35. The controller 31 controls the component units to execute the ticket examination process according to the operating program stored in the memory 32. The memory 32 stores various data including the operating program of the controller 31, passenger fares, etc. The communication unit 33 exchanges various data with the ticket issuing management center 10 through the communication. The display 34 displays various data relative to the examining process. The examination processor 35 reads data recorded on a ticket and executes the examining process based on the read data. The examining process is, for example, to judge the examination according to the read data from ticket, control the opening/closing of the gate door according to the result of this judgment and approve or reject a passenger to pass the gate passage. Further, the automatic gate apparatus 30 is able not only to execute the examining process by reading data recorded on a wireless type ticket through the wireless communication and but also to receive a magnetic type ticket and execute the examining process by reading data recorded on the magnetic ticket by a magnetic head.

The ticket issuing apparatus 40 is installed to, for example, respective trains 50 and is composed of a controller 41, a memory 42, a communication unit 43, a display 44 and a ticket issuing processor 45. The controller 41 controls the component units according to the operating program stored in the memory 42 and issues tickets from the ticket issuing processor 45. The memory 42 stores various data including the operating program of the controller 11. The communication unit 43 exchanges various data with the ticket issuing management center 10 through the wireless communication. The display 44 displays various data relative to the ticket issuing. The ticket issuing processor 45 issues tickets according to ticket issuing data that is transmitted from the ticket issuing management center 10.

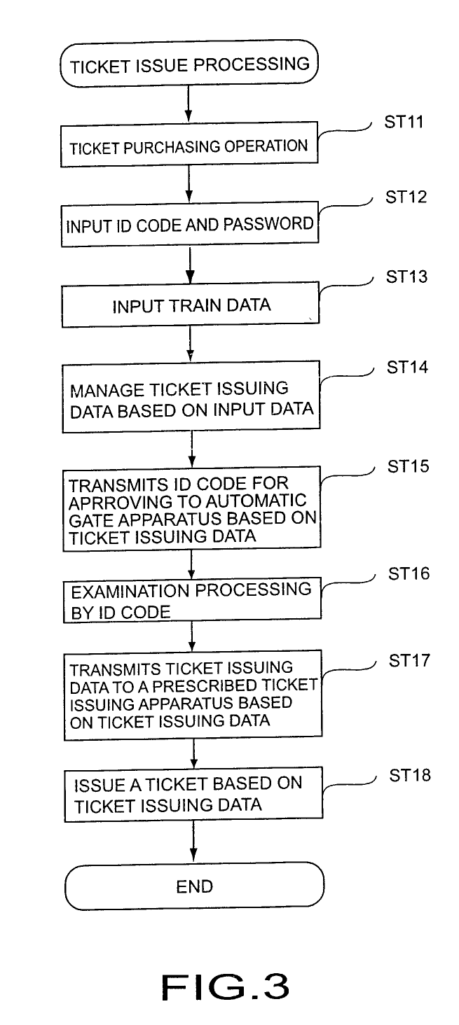

FIG. 3 is a flowchart for explaining the ticket issuing process according to the ticket issuing and examining system.

A user who desires the ticket issuing process according to the ticket issuing and examining system applies the ticket issue in advance to an entrepreneur of this system. In response to this application, the entrepreneur issues an ID card recording an ID code thereon for identifying a user and an ID code notification document. The ID code annotated on this ID code notification document is used jointly with, for example, a password that is designated in advance by a user. Further, when the ID card is issued, a phone number, an Internet mail address, etc. are optionally recorded on the ID card.

A user who receives an ID card and an ID code notification document and knows a password is able to receive the ticket issuing process according to the ticket issuing and examining system. When desires to purchase a ticket, a user operates the operation unit 25 of the terminal device 20 to purchase a ticket (ST11). In response to this ticket purchasing operation, the ticket purchasing is notified to the ticket issuing management center 10 from the communication unit 23 of the terminal device 10. At this time, the ticket issuing management center 10 demands the terminal device 20 to input an ID code and a password of a user who desires to purchase a ticket. When a correct ID code and a password are input (ST12), the ticket issuing steps are approved and the terminal device 20 is demanded to input train data such as a boarding date, a boarding section, a boarding time, a desire for a designated seat as ticket data. Further, the input of a phone number and an Internet mail address are also demanded as an option. When a boarding date, a boarding section, a boarding time, a phone number, and an Internet mail address are input (ST13), data relative to a ticket that is issued based on the input data is managed in the ticket issuing data manager 15 (ST14). For example, such data as ID Code 1234, Taro Suzuki, Phone No., an Internet male address, Date: Sep. 28, 2001, Ticket Data: Departing Time: Tokyo 10:00, Arriving Time: Shin-Osaka 13:00 and Train No. 100 (hereinafter, referred to as “Ticket Issuing Management Data A”) are managed. That is, the ticket issuing data manager 15 reserves at least ID Code “1234” and the ticket data “Departing Time: Tokyo 10:00, Arriving Time: Shin-Osaka 13:00 and Train No. 100” in the memory 12 by correlating them.

Further, the ticket data referred to here denotes data for specifying a ticket such as a boarding date, a boarding section, a train name, a designated seat number, etc.

The ticket issuing management center 10 transmits a direction to approve the pass of a user through the gate according to a prescribed ID code to a prescribed automatic gate apparatus at a specified timing according to the ticket issuing management data (ST15). This will be explained below taking a case of the Ticket Issuing Management Data A as an example.

Further, various data are transmitted to the terminal device 20 at a specified timing from the ticket issuing management center 10 using an Internet mail address included in the ticket issuing management data managed in the ticket issuing data manager 15. For example, a boarding confirmation mail is transmitted to a user of ID Code 1234 at 24 hours before the boarding. Thus, a user is able to prevent from forgetting to board on a train.

When a user desired to purchase a ticket from the terminal device 20 is going to pass through the automatic gate apparatus by carrying own ID card, the ID Code recorded on the ID card is read by the automatic gate apparatus and the examining process is executed (ST16). When a user who has an ID card containing a valid ID code passes through the gate apparatus, the on-line connected managing device is notified that the passenger started to a travel. For example, when a user who possesses an ID card recording ID Code 1234 thereon is going to pass through the automatic gate apparatus 30 at Tokyo Station on Sep. 28, 2001, an invalid ID list (a black list) is searched based on the read ID code and when this ID code is not listed on the black list, the entrance of the user is approved. Further, when the read ID Code agrees with an invalid ID code, the user is disapproved to pass through the gate apparatus.

After reading the ID code recorded on the ID card, the automatic gate apparatus 30 notifies the ticket issuing management center 10 of the passage of a user through the automatic gate apparatus 30. Corresponding to this, when a user has a cell phone as the terminal device 20, the ticket issuing management center 10 transmits such data as a platform number of a boarding train, a train number, a seat number (e.g. Seat No. 10D) to a phone number or an Internet mail address of a user who has ID Code 1234. Accordingly, a user who has a cell phone is able to know a platform number for a train to board, a train number, and a seat number.

Further, the ticket issuing management center 10 transmits ticket issuing data to a ticket issuing apparatus installed on Train 50 to which a user of ID Code 1234 boards based on the ticket data managed by the ticket issuing data manager 15 (ST17). The ticket issuing data that is transmitted here includes a seat number data that was previously notified. For example, the ticket issuing management data A (including the seat number data) is transmitted to the ticket issuing apparatus 40 installed in Train No. 100 departing Tokyo at 10:00 based on the ticket issuing management data A. The ticket issuing apparatus 40 receives this ticket issuing management data A (including Seat No. Data) and issued a ticket 2 (ST18). In this case, the ticket 2 for Tokyo to Shin-Osaka, Train No. 100, Seat No. 10D is issued. In this case, one-way ticket issue is explained but a round-trip ticket can be issued when a round-trip ticket is applied in the ticket purchasing operation by the terminal device 20. In the in-train ticket examination, a conductor delivers the issued Ticket 2 to a user who is seating in the seat of Seat No., which is recorded on the ticket.

On the ticket 2 issued from the ticket issuing apparatus, it may be recorded that the examination process was received. A user is able to pass through the automatic gate apparatus 60 installed at an arriving station with the ticket 2 delivered by the conductor.

Further, although it is explained in the above that a conductor takes an action to issue a ticket from the ticket issuing apparatus 40 installed in a train; it may be so made that a passenger himself (or herself) to take an action to get a ticket from the ticket issuing apparatus 40.

According to the embodiment explained in the above,

1) When the purchasing of a ticket is reserved through the Internet service or a cell phone, it is not required to exchange with a ticket at a station and directly boards in a train.

2) At an arriving station, the automatic gate apparatus 60 examines a ticket and therefore, a special apparatus becomes needless.

3) Electronic data can be exchanged with the ticket 2 in a train wherein a sufficient time is most available. That is, in this embodiment, it becomes possible to deliver the ticket 2 to a passenger who is in a long-distance train by a conductor who has a sufficient time to spare.

4) A conductor delivers a ticket 2 personally to a passenger in a train and therefore, the passenger feels that a special service is provided.

5) As a passenger who reserved the purchasing of a ticket through the Internet service does not require to stop at a station only for exchanging a ticket 2, the number of persons stand in a line decreases and the service to passengers who come to purchase day tickets is promoted.

Further, the present invention is not restricted to the above embodiment but can be variously modified in the execution phase without departing from its spirit and scope.

According to the present invention, it is possible to provide a ticket issuing and examining system that is capable of dissolving a waste time needed for receiving tickets.

What is claimed is:

1. A ticket issuing and examining system comprising:
a ticket issuing management center including:
means for accepting an ID code and ticket data desired to purchase that are transmitted through a communication line from a user who has an ID recording medium with an ID code recorded thereon; and
means for storing the ID code and the ticket data accepted by the accepting means by correlating them:
an automatic gate apparatus including:
means for reading the ID code from the ID recording medium;
means for judging whether the entry of a user to approve or not according to the ID code read by the reading means;
means for transmitting the ID code to the ticket issuing management center when the entry of a user is judged to be approved by the judging means; and
means for approving the entry of the user when the entry is judged to be approved by the judging means;
wherein the ticket issuing management center further including:
means for receiving the ID code transmitted from the transmitting means of the automatic gate apparatus; and
ticket data transmitting means for reading the ticket data from the storing means based on the ID code received by the receiving means and transmitting the read ticket data and the ID code;
a ticket issuing apparatus including:
means for receiving the ID code and the ticket data transmitted from the ticket data transmitting means of the ticket issuing management center; and
means for issuing a ticket based on the ticket data received by the receiving means of the ticket issuing apparatus.

2. The system according to claim 1, further comprising:
a terminal device that is connected to the ticket issuing management center through a communication line and is operated by the user who has the ID recording medium with the ID code recorded thereon.

3. The system according to claim 2, wherein the terminal device includes at least one of a personal computer, a cell phone, a portable terminal device and a stationary phone.

4. The system according to claim 1, wherein the ticket data includes a boarding date, a boarding section and a train data.

5. The system according to claim 3, wherein the ticket issuing management center includes:
means for tranmitting a platform number which should be used by the user to the cell phone or the portable terminal device when the user who has the cell phone or the portable terminal device passes the automatice gate apparatus.

6. The system according to claim 1, wherein the ticket issuing apparatus is installed in a train where the user boards and is operated by a trainman.

7. The system according to claim 1, wherein the ticket issuing apparatus is installed in a train where the user boards and is operated by the user.

8. A method for issuing a ticket comprising:
receiving an ID code and ticket data of a ticket desired by a user to purchase that are transmitted from the user who has an ID recording medium with the ID code recorded thereon through a communication line by the ticket issuing management center;
storing the received ID code and the ticket data in a storing means of the ticket issuing management center by correlating them;
reading the ticket data from the storing means according to the received ID code and transmitting the read out ticket data and the ID code to a ticket issuing apparatus;
receiving the ID code transmitted from the ticket issuing management center by an automatic gate apparatus;
judging whether the passage of the user having the ID recording medium to approve or not by the automatic gate apparatus based on the received ID code;
receiving the transmitted ticket data and ID code by the ticket issuing apparatus; and
issuing a ticket based on the received ticket data by the ticket issuing apparatus.
